(19) United States
(12) Patent Application Publication
(10) Pub. No.: US 2009/0207099 A1
(43) Pub. Date: Aug. 20, 2009

(54) Virtual screen for a storage element

(76) Inventor: Michael De Giulio, Kenilworth, IL (US)

Correspondence Address: BRINKS HOFER GILSON & LIONE, P.O. BOX 10395, CHICAGO, IL, 60610, US

(21) Appl. No.: 12/378,762

(22) Filed: Feb. 19, 2009

Related U.S. Application Data
(60) Provisional application No. 61/066,400, filed on Feb. 19, 2008.

(51) Int. Cl. G09G 5/00; H04N 9/31

(52) U.S. Cl. 345/7; 348/744; 348/E09.025

(57) ABSTRACT

A storage element with a virtual screen is provided. The storage element includes a first side panel and a second side panel, a top panel, a bottom panel and a rear panel defining an interior cavity and an open front. The storage element also includes at least one shelf within the interior cavity. An optical projection element is arranged to project a virtual screen across at least a portion of the open front in order to at least partially obscure the interior cavity from view.

### FIELD OF THE INVENTION

The present invention relates generally to the field of virtual screens. More specifically, the present invention relates to a virtual screen or light screen that projects over the front opening in a storage element, such as a kitchen cabinet in order to at least partially block a view into the interior of the storage element.

### BACKGROUND OF THE INVENTION

Storage elements such as kitchen cabinets have been used for many years to store dishware and kitchens utensils. Traditionally, kitchen cabinets include a door to close off the interior of the cabinet from view. In the past, some cabinets have included a door with a glass panel to provide a view of the interior of the cabinet. The glass could also be frosted in order to provide only a limited view of the interior. Lighting elements may also be placed within the interior of the cabinet in order to create a desired aesthetic appearance. Alternatively, storage elements have been designed without a door to allow the items stored therein to be completely visible and accessible to from the outside.

In today's society, many kitchens are designed to have a very modern and contemporary presentation including access to current technology such as the Internet In order to achieve such designs, many kitchen designers use many modern materials and futuristic high tech designs. One issue associated with such designs is the use or absence of a kitchen cabinet door. While the absence of a door allows a user to have immediate access to the interior of a kitchen cabinet, it introduces the interior and the elements stored therein to the visual appearance of the kitchen. On the other hand, while a door can be used to prevent a view of the interior of the cabinet, it can prevent a user from having immediate access to the interior.

Accordingly, there exists a need for a storage element that can provide a level of screening to block a view of the interior of storage element while also providing a user with immediate access to the item stored in the interior of the storage element. There also exists a need for a screening element that could be adjusted by a user to suit their particular needs and style requirements.

### SUMMARY OF THE INVENTION

The present invention is directed to a storage element with a virtual screen that at least partially obscures the interior thereof from view.

According to a first aspect of the invention, a storage element with a virtual screen is provided. The storage element includes a first side panel and a second side panel, a top panel, a bottom panel and a rear panel defining an interior cavity and an open front. The storage element also includes at least one shelf within the interior cavity. An optical projection element is arranged to project a virtual screen across at least a portion of the open front in order to at least partially obscure the interior cavity from view.

According to a second aspect of the invention, a storage element with a virtual screen is provided. The storage element includes a first side panel and a second side panel, a top panel, a bottom panel and a rear panel defining an interior cavity and an open front. The storage element also includes at least one shelf within the interior cavity. A first array of light projection elements is arranged to project a pattern of light across at least a portion of the open front in order to at least partially obscure the interior cavity from view.

According to a third aspect of the invention, a storage element with a virtual screen is provided. The storage element includes a first side panel and a second side panel, a top panel, a bottom panel and a rear panel defining an interior cavity and an open front. The storage element also includes at least one shelf within the interior cavity. An array of light projection elements is arranged to project a virtual screen across at least a portion of the open front from in order to at least partially obscure the interior cavity from view. The array of light projection elements are located adjacent a first front edge portion of the storage element. A reflector is mounted adjacent the array of light projection elements in order reflect the light into a concentrated beam projecting across the open front of the storage element.

The present invention, together with the attendant objects and advantages, will be best understood with reference to the detailed description below in connection with the attached drawings.

### BRIEF DESCRIPTION OF THE DRAWINGS

FIG. 1 is an illustration of a storage element in accordance with a first embodiment of the present invention showing the virtual screen;

FIG. 2 is an illustration of the storage element of FIG. 1 without the virtual screen turned on;

FIG. 3 is an enlarged plan of an embodiment of the invention;

FIG. 4 is an enlarged plan view of another embodiment of the invention; and

FIG. 5 is an enlarged plan view of a light source embodiment used to create the virtual screen.

### DETAILED DESCRIPTION OF THE PREFERRED EMBODIMENTS

The present invention is directed broadly to a storage element having a virtual screen covering a front opening. As used herein, “storage element” is intended to be interpreted broadly to include a wide range of storage devices such as kitchen cabinets and other known storage elements that use or could use a door. The virtual screen is also intended to obscure the interior contents of the storage element. It is intended that this term also be interpreted broadly to include a range of options from only slightly obscuring the interior to substantially or completely obscuring the contents of the storage element from view. Another advantage of the present invention is to purify the volume of air within the space through the use of UV light as UV light is a natural air purifier.

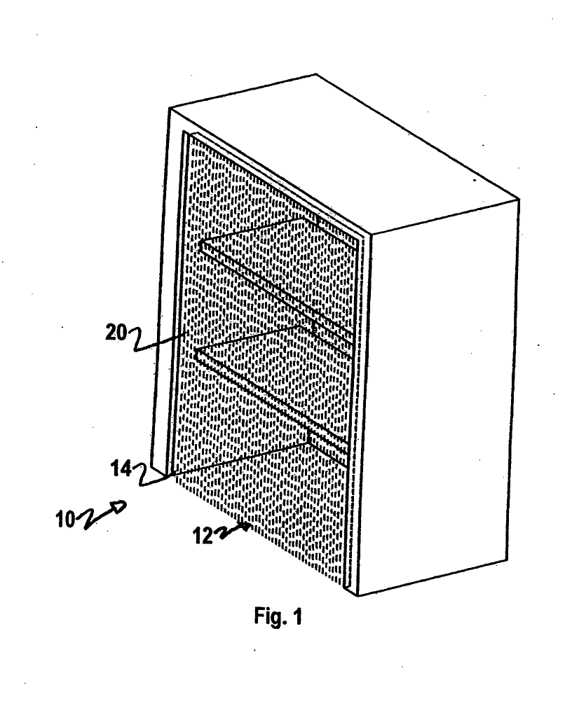

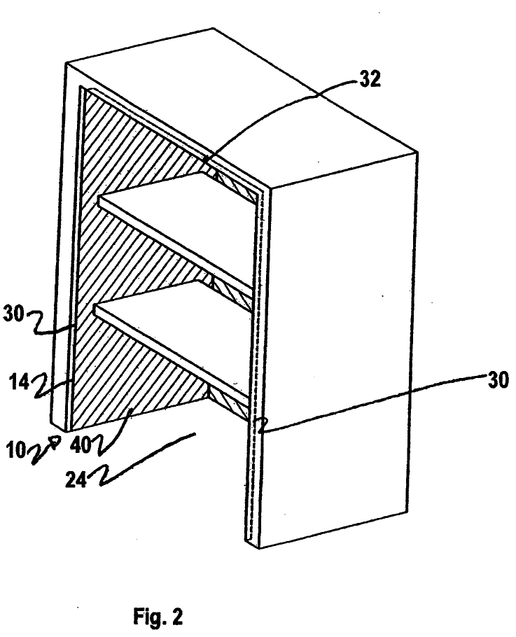

FIG. 1 is an illustration of a first embodiment of the present invention 10 illustrating the storage element 10 and-a virtual screen or light shade 12. A light source 14 is mounted on the side of the storage element 10 so as to project a light screen 12 or series of beams across the front surface 20 of the storage element 10. As a result, the interior 24 (see FIG. 2) can be partially or totally blocked from view. The present invention may also optionally include a motion sensor as known to those of ordinary skill in the art. The motion sensor may be used to turn the power off and on for the light source 14 thereby turning off and on the virtual screen 12. For example, as a user approached the storage element 10, the virtual screen 12 could also be turned off as shown in FIG. 2 so as to fully reveal the contents of the interior 24 of the storage element 10. In addition, the present invention could be used purify-the volume of air within the space through the use of UV light.

With reference to FIG. 2, the light source 14 may be mounted in the sides 30, the top 32 and optionally to a bottom surface (if available) of the storage element 10. The walls forming the interior 24 of the storage element 10 may also include a highly reflective material 40 such as those known in the art to assist in the creation of the virtual screen 12.

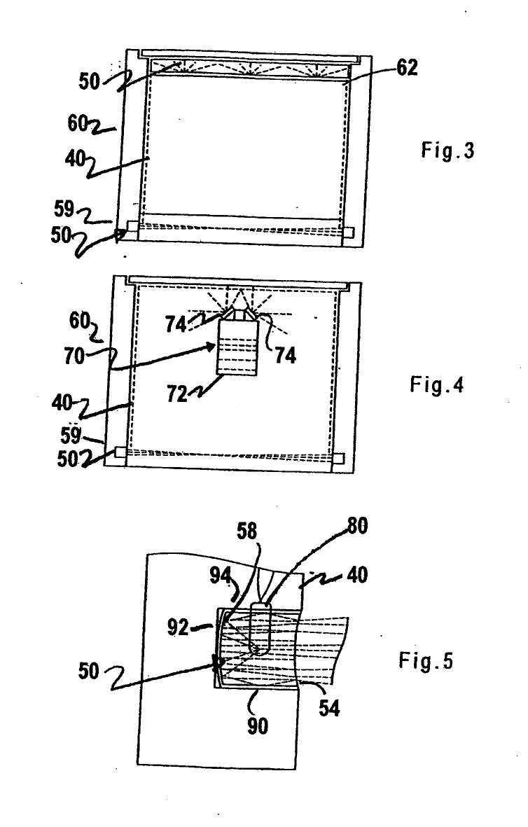

FIGS. 3-5 illustrate embodiments of the light source 14. With reference to FIGS. 3 and 5, a light source embodiment 50 is illustrated. The light source 50 is set into a glass strip that is slightly concave on the projection edge 54 (see FIG. 5) to concentrate the light beam back toward the center and concave on a back edge 58 to reflect the beam back through the glass toward a center to create a plane of light or virtual screen to visually obscure objects within the interior of storage element. With reference particularly to FIG. 3, the light source 50 is mounted to the front portion 59 of the side 60 of the storage element 10. A highly reflective material 40 is placed within the interior walls of the storage element 10. In the embodiment of FIG. 3, the light source 50 is mounted behind the horizontal shelf 62 to assist in the creation of the virtual screen 12. With reference to FIG. 4, an alternate embodiment of the light source is illustrated through the use of the vertical totem element 70. The totem element 70 includes the stand 72 and the light emitting elements 74. The light emitting elements 74 again project light to the highly reflective side surfaces 40. This embodiment also includes the light source 50 mounted to the front portion 59 of the side 60 of the storage element 10 as shown in FIG. 3.

FIG. 5 best illustrates an embodiment of the light source 50. The light source 50 includes a series of light emitting elements 80 set into a glass strip with one light emitting element illustrated in FIG. 5. The light emitting element 80 can include a wide range of light sources such as incandescent, led or laser light sources. In addition, other light sources known to those of ordinary skill in the art may also be implemented. The light source 50 includes a concave projection edge 54 to concentrate the associated light beam back toward the center. The back edge 58 is slight concave to reflect the associated light beam back toward the center as well. The three sides 90, 92, 94 also include a highly reflective coating such as silver mirror like coating to assist in the creation of the associated light beam. Again, a highly reflective material is used to coat the interior of the storage element 10.

The embodiments described above and shown herein are illustrative and not restrictive. The scope of the invention is indicated by the claims rather than by the foregoing description and attached drawings. The invention may be embodied in other specific forms without departing from the spirit of the invention. For example, the type and size of specific construction of the storage element may be designed in alternate styles as recognized by those of ordinary skill in the art. In addition, a wide range of light sources may also be implemented with the present invention. Accordingly, these and any other changes which come within the scope of the claims are intended to be embraced herein.

I claim:

1. A storage element with a virtual screen comprising:
a) a first side panel and a second side panel, a top panel, a bottom panel and a rear panel defining an interior cavity and an open front,
b) at least one shelf within the interior cavity;
c) an optical projection element arranged to project a virtual screen across at least a portion of the open front from in order to at least partially obscure the interior cavity from view.

2. The storage element of claim 1 further comprising a motion sensor.

3. The storage element of claim 2 wherein the motion sensor is operable to turn off the optical projection element.

4. The storage element of claim 1 wherein the optical projection element includes a laser.

5. The storage element of claim 1 wherein the optical projection element includes an LED.

6. The storage element of claim 1 wherein the optical projection element is located adjacent a front edge portion of the storage element.

7. The storage element of claim 1 wherein the storage element is kitchen cabinet.

8. The storage element of claim 1 wherein the interior cavity includes a highly reflective material.

9. The storage element of claim 1 wherein the highly reflective material includes a silver colored material.

10. A storage element with a virtual screen comprising:
a) a first side panel and a second side panel, a top panel, a bottom panel and a rear panel defining an interior cavity and an open front,
b) at least one shelf within the interior cavity;
c) a first array of light projection elements arranged to project a pattern of light across at least a portion of the open front in order to at least partially obscure the interior cavity from view.

11. The storage element of claim 10 wherein the first array of light projection elements are an array of laser light sources.

12. The storage element of claim 10 wherein the first array of light projection elements are an array of LEDs.

13. The storage element of claim 11 further comprising an electrical power source connected to the first array of light projection elements.

14. The storage element of claim 13 wherein the first array of light projection elements are located adjacent a first front edge portion of the storage element.

15. The storage element of claim 14 further comprising a second array of light projection elements located a second front edge portion of the storage element.

16. The storage element of claim 15 wherein the first array of light projection elements and the second array of light projection elements intersect.

17. The storage element of claim 16 further comprising a light attenuation element adjacent the first array of light projection elements.

18. The storage element of claim 16 wherein the interior cavity includes a reflective surface.

19. A storage element with a virtual screen comprising:
a) a first side panel and a second side panel, a top panel, a bottom panel and a rear panel defining an interior cavity and an open front,
b) at least one shelf within the interior cavity;
c) an array of light projection elements arranged to project a virtual screen across at least a portion of the open front from in order to at least partially obscure the interior cavity from view, wherein the array of light projection elements are located adjacent a first front edge portion of the storage element; and
d) a reflector is mounted adjacent the array of light projection elements in order reflect the light into a concentrated beam projecting across the open front of the storage element.

20. The storage element of claim 19 further comprising a motion detection sensor connected to the optical projection element.
